(19) United States
(12) Patent Application Publication
(10) Pub. No.: US 2003/0206358 A1
(43) Pub. Date: Nov. 6, 2003

(54) Head instability detection for a data storage device

(76) Inventors: David Kok Leong Loh, Singapore (SG); San Yuan Liew, Singapore (SG); Xia Lan, Singapore (SG); Myint Ngwe, Singapore (SG); Kian Wai Ng, Singapore (SG)

Correspondence Address: Mitchell K. McCarthy, Seagate Technology LLC, OKM270, 10321 West Reno, Oklahoma City, OK, 73127-7140, US

(21) Appl. No.: 10/406,117

(22) Filed: Apr. 3, 2003

Related U.S. Application Data
(60) Provisional application No. 60/377,585, filed on May 3, 2002.

(51) Int. Cl. G11B 27/36; G11B 21/02

(52) U.S. Cl. 360/31; 360/75

(57) ABSTRACT

A method for determining whether a head of a data storage device exhibits head instability. A disc attached to a spindle motor is accelerated to an operating rotational velocity to aerodynamically support the head, the head is positioned over a portion of the disc and a pattern of selected frequency is written. A readback signal is provided to a head instability detection circuit by a magnetoresistive element of the head reading the selected frequency pattern for detection and comparison of an occurrence of randomly repeatable amplitude spikes in relation to predetermined threshold levels.

### RELATED APPLICATIONS

This application claims priority to U.S. Provisional Application No. 60/377,585 filed May 3, 2002, entitled HEAD INSTABILITY BASELINE SWITCH DETECTION BY USING ADC SAMPLES IN CHANNEL CHIP.

### FIELD OF THE INVENTION

This invention relates generally to the field of magnetic data storage devices, and more particularly, but not by way of limitation, to identifying instability of a head of a data storage device based on baseline switch detection.

### BACKGROUND

Disc drives are used for data storage in modern electronic products ranging from digital cameras to computers and network systems. The disc drive includes a mechanical portion in the form of a head-disc assembly and an electronics portion in the form of a printed circuit board assembly that controls functions of the head-disc assembly while providing a communication interface to a host being serviced by the disc drive.

The head-disc assembly has a disc with a recording surface rotated at a constant speed by a spindle motor assembly and an actuator assembly positionably controlled by a closed loop servo system for use in accessing the stored data. The actuator assembly supports a magnetoresistive head with an inductive element, or writer, to write data to and a magnetoresistive element, or reader, to read data from the recording surface.

The disc drive market continues to place pressure on the industry for disc drives with increased capacities, higher data rates and lower costs. The magnetoresistive head is a high cost component of the disc drive. As each head passes through manufacturing processes in preparation for use in a disc drive, costs associated with those processes accrue and contribute to the overall cost of the disc drive. By measuring characteristics of the head throughout the manufacturing process, defective and marginally defective heads can be culled from the process before additional costs are needlessly applied.

Head instability is a concern in disc drives. In such context, magnetoresistive heads are especially prone to displaying head instability (spurious noise in a read signal, also referred to as DC spikes). The type of noise displayed by a non-stable head is classified under random telegraph noise, and is caused by local magnetic fluctuations (also referred to as magnetic switching) between two or more magnetic states within the pinned or free layers in the magnetoresistive element. A presence of randomly occurring DC spikes within the read signal will create unwanted noise in the system that degrades the integrity of the read back signal. Also, due to this unstable magnetic switching, head life is substantially shortened thereby affecting drive reliability.

As such, challenges remain and a need persists for effective techniques for determining head instability within a disc drive during the manufacture of the disc drive. It is to this and other features and advantages set forth herein that embodiments of the present invention are directed.

### SUMMARY OF THE INVENTION

As exemplified herein, embodiments of the present invention are directed to categorization of a head as either displaying a presence or absence of head instability.

Categorization of an instability status of the head is based on detection of a characteristic amplitude spike in a readback signal obtained as a read element of the head responds to a selected frequency pattern written to a magnetic recording surface adjacent the head. The readback signal is provided to a head instability detection circuit for detection and comparison of an occurrence of baseline switching in relation to predetermined threshold levels.

A system for detecting a head exhibiting head instability includes: a rotatable magnetic recording surface with a selected constant frequency pattern written thereon, the rotatable magnetic recording surface establishing fluidic currents during rotation sufficient to aerodynamically support the head adjacent the surface; and a head instability detection circuit, which includes: a first register providing a predetermined amplitude threshold value; a first comparator communicating with a read/write channel and the first register identifying an occurrence of an amplitude of a baseline switch signal exceeding a predetermined amplitude threshold value; a counter communicating with the first comparator accumulating the occurrence of the amplitude of the baseline switch signal exceeding the predetermined amplitude threshold; and a second comparator evaluating whether the accumulated occurrence of the amplitude of the baseline switch signal exceeding the predetermined amplitude threshold surpasses a predetermined occurrence threshold, to determine whether the head exhibits head instability.

These and various other features and advantages, which characterize the present invention, will be apparent from reading the following detailed description and a review of the associated drawings.

### BRIEF DESCRIPTION OF THE DRAWINGS

FIG. 1 is a top plan view of a disc drive that incorporates a head screened for head instability.

FIG. 2 is a functional block diagram of a circuit for controlling operation of the disc drive of FIG. 1. The circuit includes a portion for determining instability of the head of FIG. 1.

FIG. 3 is a graphical representation of a read signal of a constant frequency pattern written to a corresponding disc as read by a head void of head instability.

FIG. 4 is a graphical representation of a read signal of a constant frequency pattern written to a corresponding disc as read by a head displaying head instability.

FIG. 5 is a functional block diagram of a head instability detection circuit portion of the circuit of FIG. 2 for use in determining instability of the head of FIG. 1.

FIG. 6 is a flow chart of a characterization process for characterizing head instability of the head of the disc drive of FIG. 1.

FIG. 7 provides a functional block diagram of a system configured to carry out the routine of FIG. 4 in accordance with preferred embodiments of the present invention.

### DETAILED DESCRIPTION

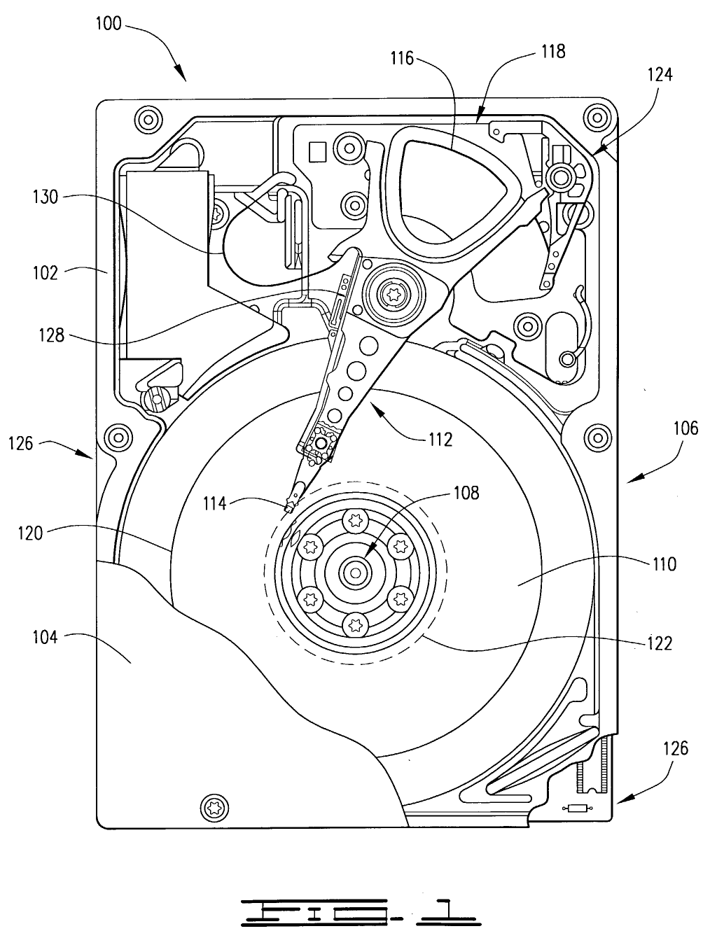

Referring now to the drawings, FIG. 1 provides a top plan view of a data storage device 100 (also referred to as an apparatus for storing data 100). The data storage device 100 includes a rigid base deck 102, which cooperates with a top cover 104 (shown in partial cutaway) to form a sealed housing for a mechanical portion of the data storage device 100. The mechanical portion of the data storage device 100 is referred to as a head-disc assembly (HDA) 106. A spindle motor 108 rotates a number of magnetic data storage discs (disc) 110 at a constant high speed. A rotary actuator 112 supports a number of data transducing heads 114 adjacent the discs 110. The actuator 112 is rotated through application of current to a coil 116 of a voice coil motor (VCM) 118.

During data transfer operations with a host device (not shown), the actuator 112 moves the heads 114 to data tracks 120 (also referred to as an information track 120) on the surfaces of the discs 110 to write data to and read data from the discs 110. When the data storage device 100 is deactivated, the actuator 112 moves the heads 114 to texturized landing zones 122; the actuator 112 is then confined by latching a toggle latch 124.

Command and control electronics, as well as other interface and control circuitry for the data storage device 100, are provided on a printed circuit board assembly 126 mounted to the underside of the base deck 102. A component used in conditioning read/write signals passed between the command and control electronics of printed circuit board assembly 126 and the head 114 is a preamplifier/driver (preamp) 128. The preamp 128 prepares a read signal acquired from an information track, such as 120, by the head 114 for processing by read/write channel circuitry (not separately shown) of the printed circuit board assembly 126. The preamp 128 is attached to a flex circuit 130, which conducts signals between the printed circuit board assembly 126 and the head 114 during data transfer operations.

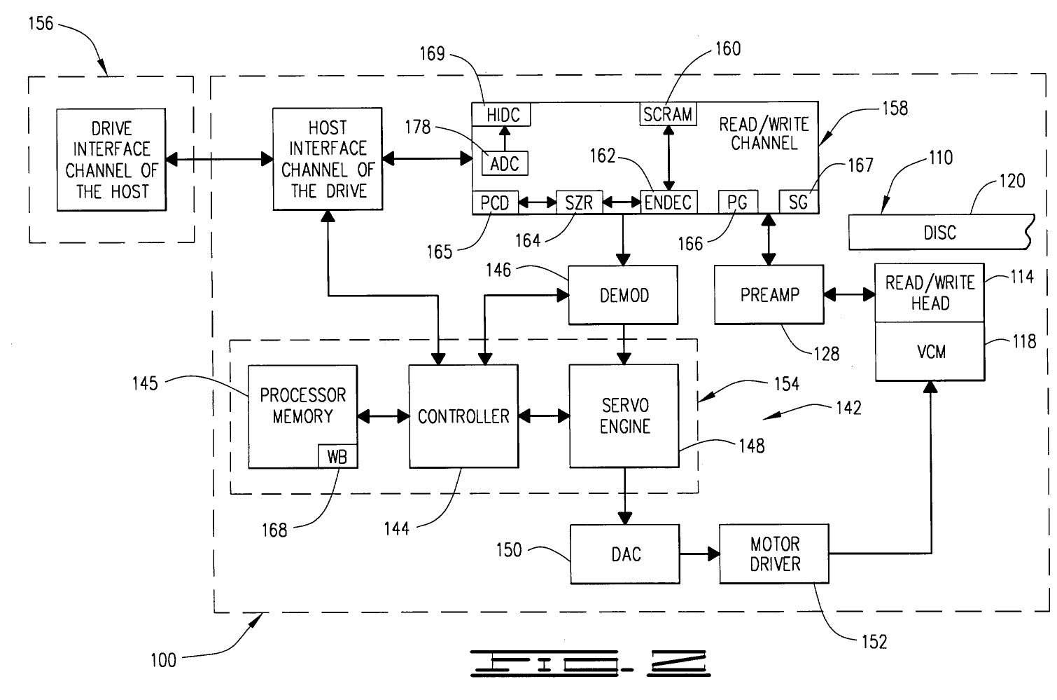

Turning to FIG. 2, position-controlling of the head 114 is provided by the positioning mechanism (not separately shown) operating under the control of a servo control circuit 142 programmed with servo control code, which forms a servo control loop.

The servo control circuit 142 includes a micro-processor controller 144 (also referred to herein as controller 144), a processor memory 145, a demodulator (DEMOD) 146, an application specific integrated circuit (ASIC) hardware-based servo controller (“servo engine”) 148, a digital to analog converter (DAC) 150 and a motor driver circuit 152. Optionally, the controller 144, the processor memory 145, and the servo engine 148 are portions of an application specific integrated circuit 154.

The demodulator 146 conditions head position control information transduced from the information track 120 of the disc 110 to provide position information of the head 114 relative to the information track 120. The servo engine 148 generates servo control loop values used by the controller 144 in generating command signals such as seek signals used by the voice coil motor 118 in executing seek commands. Control loop values are also used to maintain a predetermined position of the voice coil motor 118 during data transfer operations.

The command signals generated by the controller 144 and passed by the servo engine 148 are converted by the digital to analog converter 150 to analog control signals. The analog control signals are used by the motor driver circuit 152 in position-controlling the head 114 relative to the selected information track 120, during track following, and relative to disc 110 during seek functions.

In addition to the servo control code program of the application specific integrated circuit 154, a control code is also programmed into the application specific integrated circuit (ASIC) 154 for use in executing and controlling data transfer functions between a host 156 and the data storage device 100. Read/write channel electronics (channel) 158, operating under control of the controller 144, passes data received from the host 156 to the head 114 for storage on the disc 110 and passes data read by the head 114 from the disc 110 back to the host 156.

The read/write channel electronics 158 includes a scrambler (SCRAM) 160 employed to ensure a nearly equal random mix of 1's and 0's. This randomization connotes that a pulse-shaping filter (not separately shown) of the read/write channel electronics 158 will roughly see an even mix of 1's and 0's. Thus, a channel loop algorithm can expect to be working on an even mix of input.

An encoder/decoder (ENDEC) 162, maps each byte of user data received from the host 156 into a corresponding code word and provides a succession of code words to a serializer (SZR) 164, which accepts the parallel bits of each of the successive code words and places those bits in a serial sequence. The serial sequence forms the input signal sequence for a precoder (PCD) 165. The precoder 165 converts the serial sequence of code words from a non-return to zero inverse (NRZI) format to a non-return to zero (NRZ) format. Under a NRZI format, each “1” represents a transition in a physical property of the information track 120 and a “0” represents no transition. Under a NRZ format, a “1” represents one property state for the information track 120 and a “0” represents a second property state for the information track 120.

Additionally, the read/write channel electronics 158 includes a preamble generation/detection portion (PG) 166 and a sync mark generation/detection portion (SG) 167 for use in respectively generating and detecting a preamble field portion and a sync mark portion of a sector header.

In a preferred embodiment, an algorithm programmed in the ASIC 154 turns off the scrambler 160, the encoder/decoder 162 and the precoder 165 while the head 114 passes a readback signal, obtained by reading a selected frequency pattern prewritten to a super sector of the information track 120, to the preamp 128. The super sector includes substantially all of the recording media between each servo wedge of the information track 120.

The selected frequency pattern written to the super sector of the information track 120 includes a normal sector header preceding a DC erase pattern (0000). The sector header includes the preamble field and the sync mark for use by timing recovery in synchronizing the read/write channel electronics 158 to the data in the super sector. Prior to writing the DC erase pattern (0000) to the super sector, the DC erase pattern is loaded into a write buffer (WB) 168 of the processor memory 145. The DC erase pattern is read back from the write buffer 168 and written to the super sector during a super sector write process.

While reading the selected frequency pattern from the super sector, the preamble and the sync mark allow for normal gain, frequency and phase adaptation. After which, while the servo control circuit 142 is operating in tracking mode, all adaptive loops are frozen so that the divergence of the loops is prevented.

The present invention (as embodied herein and as claimed below) provides a novel approach to characterizing baseline switching of a selected head 114. The approach entails use of a head instability detection circuit 169 during an evaluation of the readback response, of the head 114 reading a constant frequency pattern written to a corresponding disc.

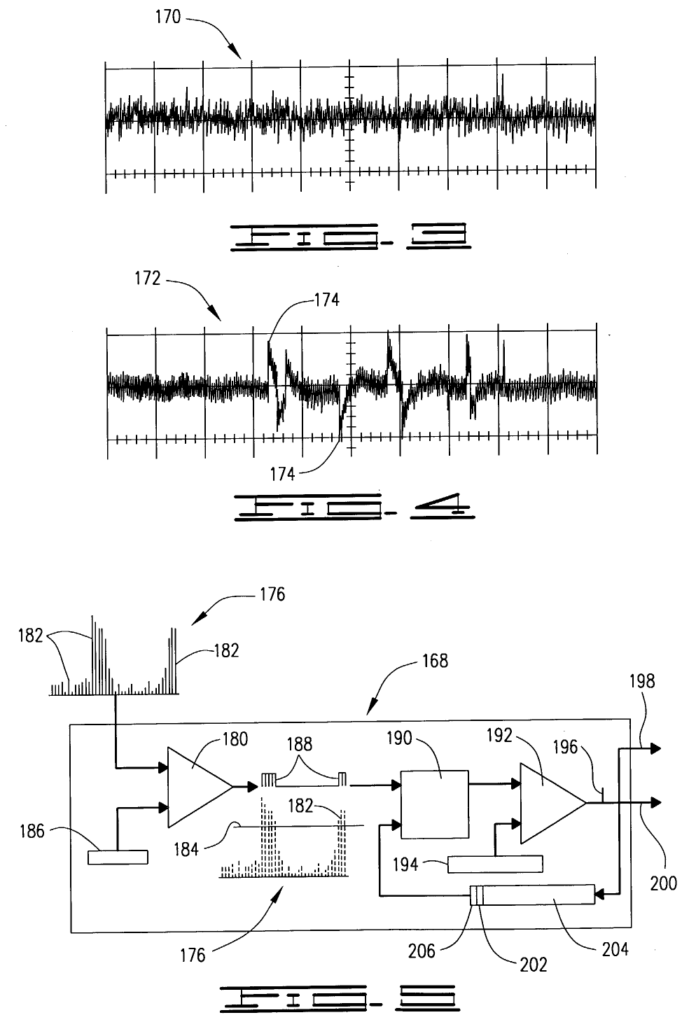

As will be recognized, an amplitude of a stable readback signal 170 provided by a selected head 114 (absent baseline switching) reading a constant frequency pattern of a previously written DC erase pattern (i.e., a ‘0000 . . . 0’ pattern) will display a substantially uniform, spikes free, DC signal, as shown by FIG. 3. However, an amplitude of an unstable readback signal 172 obtained from a selected head 114 displaying a presence of baseline switching will display a non-uniform signal containing randomly repeatable occurrences of DC spikes 174, as shown by FIG. 4, as an outcome of reading a constant frequency pattern of a previously written DC erase pattern (0000). Baseline switching is a result of local magnetic fluctuations (also referred to as magnetic switching) between two or more magnetic states within the pinned or free layers in the magnetoresistive element.

It is noted that DC spikes may emanate from sources other than magnetic switching, such as magnetic anomalies within the media, thermal asperities or media defects. However, DC spikes from sources other than the magnetic material and manufacture of the magnetoresistive element of the selected head 114, are substantially repeatable in the time domain, because they are disc 110 dependent.

DC spikes resulting from randomly occurring local magnetic fluctuations between two or more magnetic states within the pinned or free layers in the magnetoresistive element, are repeatable but random in the time domain, because they are head 114 dependent. In other words, because of the instability of the magnetoresistive element, magnetic switching occurs in a non-predictable manner, while the selected head 114 is reading a pattern from the disc 110.

What is predictable is a selected head 114 with a magnetically unstable magnetoresistive element will, with a substantial level of repeatability, cause random DC spikes to be imparted to a readback signal during a read operation. The random DC spikes result from non-predictable magnetic switching of the magnetoresistive element. That is, during a read operation DC spikes will be generated that are not present in the pattern being read. The source of the DC spikes is not the pattern written to the media of the disc 110 nor is the source of the DC spikes the media of the disc 110, the source is the unstable magnetoresistive element of the selected head 114.

In a preferred embodiment, the unstable readback signal 172 is obtained by reading a predetermined number of previously written super sectors using a selected head 114 that has the baseline switching phenomena present within the magnetoresistive element. However, presence of the baseline switching phenomena (i.e., magnetic switching between two or more magnetic states within the pinned or free layers in the magnetoresistive element) within a selected head 114 is unknown until the readback 172 is analyzed by the head instability detection circuit 169 (of FIG. 2). As such, each head 114 of the data storage device 100 is sequentially selected and analyzed for head instability.

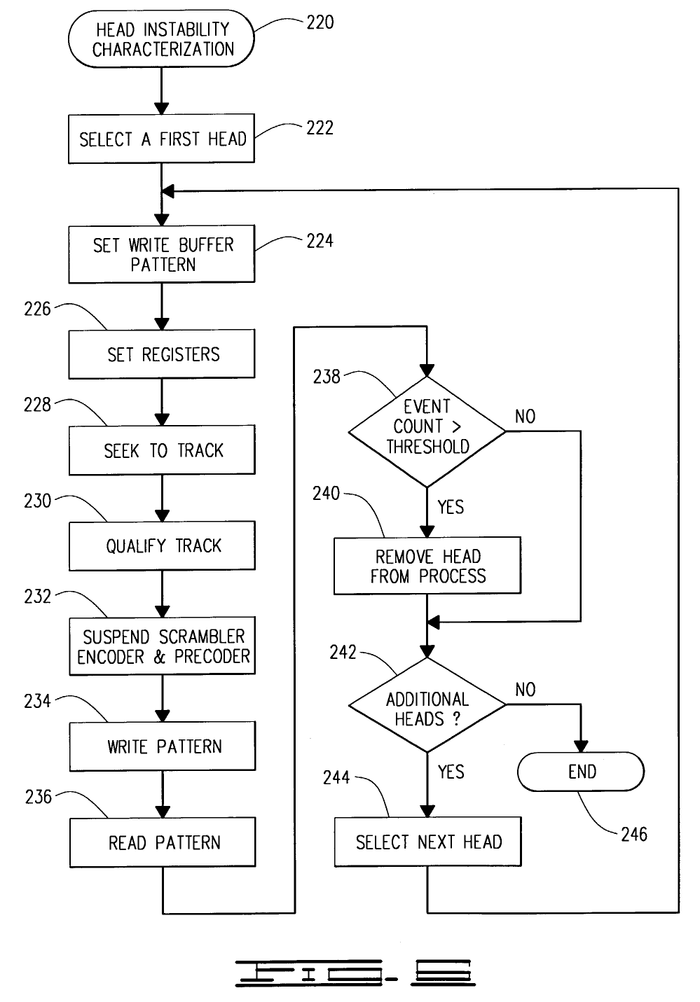

FIG. 5 shows a sampled and rectified baseline switch signal 176 provided by an analog to digital converter circuit (ADC) 178 (of FIG. 2) of the channel 158 processing the unstable readback signal 172 containing random occurrences of DC spikes 174.

A first comparator 180 of the head instability detection circuit 169 compares the amplitude of each sample 182, of the sampled and rectified baseline switch signal 176, to a predetermined amplitude threshold level 184 stored in a first register 186. The first comparator 180 outputs an occurrence signal 188 for each sample 182 of the switch signal 176 with an amplitude in excess of the amplitude threshold level 184.

Each occurrence signal 188 is passed to an accumulator 190, which accumulates a count of a number of instances the occurrence signal 188 encountered while reading the predetermined number of super sectors. An entire information track 120 (of FIG. 1) of super sectors has been found to be a convenient number of super sectors for use in determining a presence of baseline switching in a selected head 114.

At the conclusion of reading the predetermined number of super sectors, the accumulated number of instances that the occurrence signal 188 encountered while reading the predetermined number of super sectors is provided to a second comparator 192. The second comparator 192 compares the accumulated number of encountered occurrence signals 188 to a predetermined count threshold provided by a second register 194. If the accumulated number of encountered occurrence signals 188 exceeds the predetermined count threshold, a baseline switching event is deemed to have occurred, and the second comparator 192 will issue an error signal 196. The error signal 196 may be issued either to a hardware/NRZ line 198, to an error flag line 200, to set an error bit 202 in a third register 204, or to any suitable output device for use in reporting the occurrence of the baseline switching event.

The third register 204 also includes a clear accumulator bit 206 triggered by the second comparator 192, which clears the accumulated count of the second comparator 192 at the conclusion of the comparison of the accumulated number of encountered occurrence signals 188 to the predetermined count threshold.

The head instability detection circuit 169 is tunable to a desired sensitivity level by altering the amplitude threshold level 184 stored in the first register 186 and the predetermined count threshold provided in the second register 194. Both the amplitude threshold level 184 and the predetermined count threshold are empirically determined values that change for each specific data storage device type and may be derived through accelerated life testing of a selection of heads with each selected head exhibiting varying degrees of baseline switching.

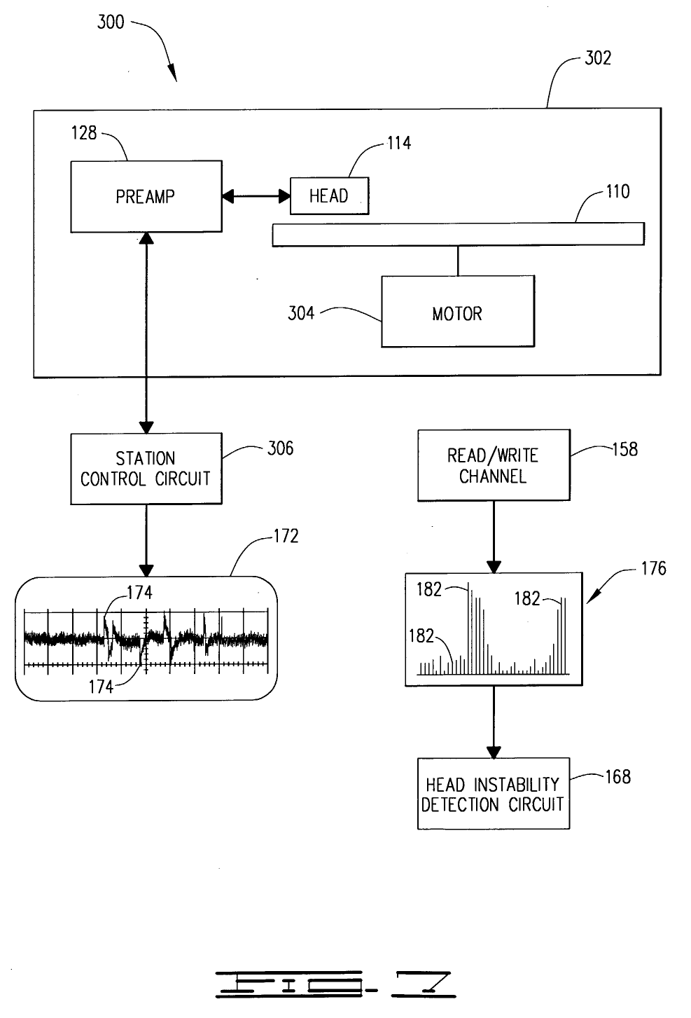

FIG. 6 provides a flow chart for a head instability characterization routine 220, generally illustrative of steps carried out in accordance with preferred embodiments of the present invention. The routine is preferably carried out during manufacturing within the confines of a data storage device (such as 100). The routine can also be carried out using a test stand, or other suitable test equipment, supporting a population of heads (such as 114).

A first head (such as 114) to be tested is selected at step 222, and a frequency pattern to be written to an associated disc (such as 110) is set in a write buffer in a volatile memory (such as 145) at step 224. Each register of a head instability detection circuit (such as 169) is set at step 226.

A first, second and third register are included as portions of the head instability detection circuit of a preferred embodiment. The first register (such as 186) is set with an amplitude threshold level (such as 184). The second register (such as 194) is set with a predetermined count threshold, while an error bit (such as 202) and a clear accumulator bit (such as 206) of the third register (such as 204) are set to zero.

At process step 228, a controller (such as 144) initiates a seek operation of the first selected head to a predetermined information track (such as 120), of a portion of the disc inaccessible for storage of customer data. A qualification of the selected information track is performed at process step 230. At process step 232, the head instability characterization routine 220 continues with suspending operation of a scrambler (such as 160), an encoder/decoder (such as 162) and a precoder (such as 165). The precoder, encoder/decoder and scrambler are portions of a read/write channel electronics (such as 158) and are operationally suspended to facilitate writing of a constant frequency DC erase pattern (0000) to the information track at process step 234.

At process step 236, the constant frequency pattern written at process step 234 is read to provide a readback signal. If the readback signal, as analyzed by the head instability detection circuit, is a stable readback signal (such as 170), the selected head is determined to be stable and absent the presence of the baseline switching phenomena. However, if upon analysis of the read back signal by the head instability detection circuit, the signal displays random DC spikes (such as 174), the readback signal is characterized as an unstable readback signal (such as 172) and the selected head is determined to be unstable, and subject to removal and replacement.

At process step 238, if, upon analysis of the readback signal, the head instability detection circuit counts an accumulated number of encountered occurrence signals (such as 188), in excess of a predetermined count threshold provided by a register (such as 204), the head instability detection circuit 169 will flag the selected head as defective and the head will be removed from the assembly process at process step 240. However, if, upon analysis of the readback signal, the head instability detection circuit fails to accumulate a number of encountered occurrence signals in excess of a predetermined count threshold at step 238, the head instability characterization process 220 proceeds to process step 242 where a determination is made as to whether or not additional heads remain to be characterized.

If additional heads remain to be characterized, the head instability characterization process 220 proceeds to process step 244 with the selection of a remaining head and cycles back through the routine with each remaining head. Upon completion of the characterization of each head, the head instability characterization process 220 concludes at end process step 246.

In another preferred embodiment, the head characterization takes place in a spin-stand to sort the heads prior to installation into the data storage device 100, with the spin-stand providing suitable mechanisms to precisely maintain the head 114 in a desired relationship with the associated disc surface.

During the practice of preferred embodiments of the present invention, it will be understood that the operational rotational velocity of the disc 110 is determined by a product specification. The nominal configuration of the heads 114 is selected to accommodate a predetermined nominal fly-height during data transfer operations with the discs 110. The frequency of the constant frequency pattern can take any suitable value based on a given configuration, and in a preferred embodiment corresponds to a constant frequency, DC erase pattern (0000).

FIG. 7 provides a system 300 configured to carry out the routine of FIG. 6 in accordance with preferred embodiments of the present invention. The system 300 includes several components discussed above including the disc 110, head 114, preamp 128 and read/write channel electronics 158 shown in FIG. 2. The system further preferably includes a housing 302 in which at least the head 114 and the disc 110 are disposed, a motor 304 used to rotate the disc 110 at a desired rotational speed, and a control circuit 306, which provides overall control of the system 300. The control circuit 306 also passes the readback signal from the preamp 128 to the read/write channel electronics 158. The channel 158 processes the readback signal and provides a sampled and rectified baseline switch signal to the head instability detection circuit 169 for analysis.

For purposes of illustration, FIG. 7 shows the unstable readback signal 172, which displays random DC spikes 174, and the sampled and rectified baseline switch signal 176 derived from processing the unstable readback signal 172.

In a preferred embodiment, the system 300 is incorporated into a spin-stand in which multiple discs 110 and heads 114 are supported. In such case the heads 114 are preferably evaluated as part of a servo track writing operation in which the aforementioned servo information is written to the disc surfaces 110. The control circuit 306 in this configuration can comprise a host computer alone or in conjunction with selected circuitry from FIG. 2 configured to carry out the routine of FIG. 4. Output from the head instability detection circuit may be optionally provided to a monitor of a computer, a manufacturing process control network or a separate data acquisition device (such as a digital oscilloscope).

In an alternative embodiment, the system 300 is embodied within the data storage device 100 so that the housing 302 corresponds to the housing formed by the base deck 102 and top cover 104, the motor 304 corresponds to the spindle motor 108 (FIG. 1) and the control circuit 306 corresponds to the controller 144 (FIG. 2). Accordingly, embodiments of the present invention are generally directed to categorization of a head (such as 114) of a data storage device (such as 100) as a head exhibiting a presence of head instability. The categorization is based on a comparison of amplitude of each sample (such as 182) of a sampled and rectified baseline switch signal (such as 176) to a predetermined amplitude threshold level (such as 184) stored in a first register (such as 186). The sampled and rectified baseline switch signal is processed from a unstable readback signal (such as 172) and analyzed by a head instability detection circuit (such as 169).

An occurrence of DC spikes (such as 174) in the readback signal above the amplitude threshold level triggers an encountered occurrence signal (such as 188) generated by a first comparator (such as 180). Based on an incidence of encountered occurrence signals in excess of a predetermined count threshold, the head instability detection circuit provides an error signal (such as 196), which signals presence of a head with excessive baseline switching and results in removal of the head from the manufacturing process.

For purposes of the appended claims, it will be understood that the disclosed structure corresponding to the recited means comprises the circuitry shown in FIG. 5.

It will be clear that the present invention is well adapted to attain the ends and advantages mentioned as well as those inherent therein. While presently preferred embodiments have been described for purposes of this disclosure, numerous changes may be made which will readily suggest themselves to those skilled in the art and which are encompassed in the appended claims.

What is claimed is:

1. A method by steps comprising:
aerodynamically supporting a head above a recording surface;
writing a selected frequency pattern to the recording surface;
comparing a randomly repeatable amplitude spike of a readback signal to a predetermined threshold for an occurrence of an amplitude of the randomly repeatable amplitude spike exceeding the predetermined threshold; and
evaluating the occurrence of the amplitude of the randomly repeatable amplitude spike exceeding the predetermined threshold relative to a predetermined occurrence count threshold to determine presence of head instability.

2. The method of claim 1, in which the randomly repeatable amplitude spike are imparted on a readback signal by an unpredictable magnetic switching of the head, the readback signal obtained as a read element of the head responds to the selected frequency pattern written to the magnetic recording surface, further comprising the steps of:
accelerating the recording surface to an operational rotational velocity;
moving the head to a region of the recording surface inaccessible for storage of customer data;
selecting a portion of the region for writing the selected frequency pattern;
disabling a scrambler portion of a read/write channel communicating with the head;
suspending operation of an encoder/decoder portion of the read/write channel;
disengaging operation of a precoder portion of the read/write channel;
enabling a preamble generation/detection portion of the read/write channel;
and
activating a sync mark generation/detection portion of the read/write channel.

3. The method of claim 2, in which the selected frequency pattern is written to the recording surface by steps comprising:
writing a preamble using the preamble generation/detection portion of the read/write channel to the portion of the region of the recording surface;
transducing a sync mark using the sync mark generation/detection portion of the read/write channel to the portion of the region of the recording surface adjacent the preamble;
loading a write buffer with the selected frequency pattern; and
recording the selected frequency pattern to the portion of the region of the recording surface adjacent the sync mark.

4. The method of claim 3, in which the head comprises a write element, and wherein the selected frequency pattern is a frequency pattern generated by a constant current applied across the write element.

5. The method of claim 4, in which the selected frequency pattern is a DC erase pattern.

6. The method of claim 1, in which the predetermined threshold is a predetermined amplitude threshold, and in which the amplitude of the randomly repeatable amplitude spike is compared to the predetermined threshold by steps comprising:
reading the selected frequency pattern with the read element of the head to provide the read signal;
processing the read signal with an analog to digital converter communicating with the head to provide a sampled and rectified baseline switch signal;
engaging a first comparator to identify the occurrence of an amplitude sampled and rectified baseline switch signal exceeding the predetermined amplitude threshold; and
accumulating the occurrence of the amplitude of the sampled and rectified baseline switch signal exceeding the predetermined amplitude threshold with a counter for use in determining presence of head instability.

7. The method of claim 6, in which the occurrence of the amplitude of the sampled and rectified baseline switch signal exceeding the predetermined amplitude threshold is evaluated relative to the predetermined occurrence threshold by steps comprising:
transferring the accumulated occurrence of the sampled and rectified baseline switch signal exceeding the predetermined amplitude threshold to a second comparator; and
engaging the second comparator to identify, as an event, the accumulated occurrence of the amplitude of the sampled and rectified baseline switch signal exceeding the predetermined amplitude threshold surpassing the predetermined occurrence threshold.

8. The method of claim 7, in which the analog to digital converter, the first comparator, the counter, and the second comparator are portions of a read/write channel.

9. The method of claim 6, in which the occurrence of the amplitude of the sampled and rectified baseline switch signal exceeding the predetermined amplitude threshold is a result of magnetic switching between two or more magnetic states within pinned or free layers of a magnetoresistive element of the head.

10. The method of claim 7, in which the predetermined amplitude threshold is stored in a first register of the read/write channel, and in which the predetermined occurrence threshold is stored in a second register of the read/write channel.

11. The method of claim 7, further comprising the steps of:
setting an error bit in response to the identification of the event to signal the head as exhibiting the presence of head instability;
signaling a clear accumulator bit to clear the counter; and
removing the head exhibiting the presence of head instability in response to the error bit signaling the presence of head instability within the head.

12. A system for detecting a head exhibiting head instability comprising:
a rotatable magnetic recording surface with a selected constant frequency pattern written thereon, the rotatable magnetic recording surface establishing fluidic currents during rotation sufficient to aerodynamically support the head adjacent the surface; and
means for determining whether the head exhibits head instability, by steps for determining whether the head exhibits head instability.

13. The system of claim 12, in which the head provides a readback signal obtained as the head responds to the selected constant frequency pattern written to the magnetic recording surface, and wherein the means for determining whether the head exhibits head instability comprising:
a preamplifier communicating with the head providing an amplified readback signal in response to the provided readback signal;
a read/write channel communicating with the preamplifier providing a sampled and rectified baseline switching signal in response to the provided amplified readback signal; and
a head instability detection circuit communicating with the read/write channel determining whether the head exhibits head instability in response to the provided sampled and rectified baseline switching signal.

14. The system of claim 13, in which the head instability detection circuit comprises:
a first register providing a predetermined amplitude threshold value;
a first comparator communicating with the read/write channel and the first register identifying an occurrence of an amplitude of the baseline switch signal exceeding the predetermined amplitude threshold value;
a counter communicating with the first comparator accumulating the occurrence of the amplitude of the baseline switch signal exceeding the predetermined amplitude threshold for use in determining presence of head instability; and
a second comparator evaluating whether the accumulated occurrence of the amplitude of the baseline switch signal exceeding the predetermined amplitude threshold surpasses a predetermined occurrence threshold, thereby determining whether the head exhibits head instability.

15. The system of claim 12, further comprising a preamplifier communicating with the head, and a read/write channel communicating with the preamplifier, and further in which the steps for determining whether the head exhibits head instability comprise:
aerodynamically supporting a head above a recording surface;
writing a selected frequency pattern to the recording surface;
comparing a randomly repeatable amplitude spike of a readback signal to a predetermined threshold for an occurrence of an amplitude of the randomly repeatable amplitude spike exceeding the predetermined threshold; and
evaluating the occurrence of the amplitude of the randomly repeatable amplitude spike exceeding the predetermined threshold relative to a predetermined occurrence count threshold to determine presence of head instability.

16. The system of claim 15, in which the randomly repeatable amplitude spike is imparted on the readback signal by an unpredictable magnetic switching of the head, the readback signal is obtained from a read element of the head responding to the selected frequency pattern written to the magnetic recording surface, and in which the predetermined threshold is a predetermined amplitude threshold, and further in which the amplitude of the randomly repeatable amplitude spike of the readback signal is compared to the predetermined threshold for identification of an occurrence of the amplitude of the randomly repeatable amplitude spike exceeding the predetermined threshold by steps comprising:
reading the selected constant frequency pattern with the read element of the head to provide the read signal;
processing the read signal with an analog to digital converter communicating with the preamplifier to provide a sampled and rectified baseline switch signal;
engaging a first comparator to identify the occurrence of an amplitude of the sampled and rectified baseline switch signal exceeding the predetermined amplitude threshold; and
accumulating the occurrence of the amplitude of the sampled and rectified baseline switch signal exceeding the predetermined amplitude threshold with a counter for use in determining presence of head instability.

17. The method of claim 16, in which the occurrence of the randomly repeatable amplitude spike exceeding the predetermined amplitude threshold is evaluated relative to the predetermined occurrence threshold by steps comprising:
transferring the accumulated occurrence of the amplitude of the sampled and rectified baseline switch signal exceeding the predetermined amplitude threshold to a second comparator; and
engaging the second comparator to identify, as an event, the accumulated occurrence of the amplitude of the sampled and rectified baseline switch signal exceeding the predetermined amplitude threshold surpassing the predetermined occurrence threshold.

18. A data storage device comprising:
a head disc providing a readback signal; and
a printed circuit board with means for processing the readback signal to determine presence of head instability.
